(19) United States
(12) Patent Application Publication
(10) Pub. No.: US 2007/0174636 A1
(43) Pub. Date: Jul. 26, 2007

(54) Methods, systems, and apparatus for encrypting e-mail

(76) Inventor: Robert Raja, Chetpet (IN)

Correspondence Address: DAVID P. LENTINI, 1932 CALIFORNIA STREET, SAN FRANCISCO, CA, 94109-4407, US

(21) Appl. No.: 11/360,449

(22) Filed: Feb. 23, 2006

(30) Foreign Application Priority Data
Feb. 23, 2005 (IN) 152/CHE/2005
Feb. 23, 2005 (IN) 153/CHE/2005

(51) Int. Cl. G06F 12/14; H04L 9/00; H04L 9/32; G06F 11/30

(52) U.S. Cl. 713/189; 380/278; 380/285

(57) ABSTRACT

Systems, methods, and apparatus for securely encrypting electronic mail (e-mail) are presented. In some examples, a system for sending encrypted electronic messages includes a client computer configured to compose an electronic text message and define at least one recipient address. The computer is in contact with a mail server that is configured to take an electronic text message, at least one recipient address, and, optionally, a file attachment, and format such into an e-mail including an e-mail header. Both user and recipient are provided with unique Numerical Ids that are sent to a public key distribution server that is configured to receive the Numerical Ids and return a public key specific to the recipient for encrypting the e-mail.

### CLAIMS TO FOREIGN PRIORITY

This application claims priority under 35 U.S.C. §119(a) form Indian Patent Application Serial No.: 152/CHE/2005 and Indian Patent Application Serial No.: 153/CHE/2005, both filed 23 Feb. 2005. The disclosures of these two applications are incorporated herein by reference in their entireties and for all purposes.

### COPYRIGHT NOTICE

A portion of the disclosure of this patent document contains material that is subject to copyright protection. The copyright owner has no objection to anyone reproducing the patent disclosure as it appears in the Patent and Trademark Office patent files or records. However, the copyright owner strictly reserves all other copyrights.

### BACKGROUND OF THE INVENTION

3.1 Field of the Invention

The present invention relates to electronic communications, and, more specifically, to sending electronic mail (i.e., “e-mail”) using message encryption. The present invention thus has applications in the areas of telecommunications and computer science.

3.2 The Related Art

E-mail has become one of the most preferred methods for communicating in today's hectic world, driven mainly by the phenomenal increase in the pace of both personal and business transactions across the world using computer network technologies. The popularity of e-mail arises in part from its combination of the advantages of letter writing, such as expressing large amounts of information in textual and graphical format, with the immediacy of telephonic communication. Thus, users can send complex technical and legal information in the blink of an eye to one or more recipients who can view the information at their convenience for as long and often as they desire.

But the very ease of e-mail also presents certain insidious security risks. By default, e-mails pass through and sometimes reside in multiple servers in plain (i.e., ASCII) text status before they are delivered to the recipient. Thus, e-mail is vulnerable to unauthorized viewing or tampering at these intermediate locations. Even after the e-mail reaches the recipient, it still resides in the local system in plain text form if the recipient uses a mail client. This retention of the raw data content of the e-mail poses significant privacy risks in many forms to all users of the e-mail system.

For example, most e-mail services allow users to identify and authenticate themselves for accessing their mailboxes through a usemame and password combination. But this system of identification and authentication is not foolproof, since many ways exist for gaining unauthorized access into electronic mailboxes. For example, unauthorized access can be made by persons close to the mailbox owner who may or may not share his computing system, by unrelated persons who consider breaking passwords a challenge, by e-mail service owners either for the purpose of complying with the law or for displaying context sensitive advertisements, by criminals for pursuing criminal activities using other persons” e-mail addresses, and by spyware and computer viruses among others.

Another bane of the e-mail system is the risk of identifying an e-mail wrongly as originating from someone other than the person who sent the message. Such e-mail “spoofing”, which includes phishing, has been used for identity theft and is responsible for the loss of millions of dollars annually. This situation can be adequately taken care of by cryptographically authenticating the source of e-mail messages before they are sent to the recipients. Source authentication ensures that the recipients can verify the source of the e-mails they receive before initiating any kind of response pertaining to the same.

The MIME (Multipurpose Internet mail Extension) specification and the more recent S/MIME specification proposed by the IETF RFCs 2311, 2312, 2633, and 2634 describe protocols for securing e-mail. MIME specifies the format for non-ASCII messages (including graphics, photos, sound and video files) and formatted text documents that are sent over the Internet. S/MIME is a later version of MIME, which, in addition to specifying the format of e-mail messages, also specifies formats for combining cryptographic services with the e-mail.

Other programs depend heavily on the Public Key Infrastructure (PKI) model for securing e-mail. The PKI model combines symmetric- and asymmetric key cryptography to form a secure key pair used to encrypt information. In many of these models, a central authority, referred to as the Certification Authority, maintains the public keys of all users. This could be a trusted person, business or government. For ease of identification of public keys as belonging to a particular person, device or computer, the name, country, e-mail address and other relevant details of the owner, together with his public key are packaged into a digital certificate, which is then authenticated by the certification authority. The certificates are then used by relying parties who are users who depend on the information contained in the digital certificate including the public key of the owner of the certificate. There may be one Certification Authority from whom trust may flow directly to the relying party user who uses a digital certificate or a hierarchy of certification authorities wherein trust flows from the root of the hierarchy down the line to the end user who uses the digital certificate. The certification authority, in addition to issuing and maintaining digital certificates provides service to persons requesting public keys and keeps track of digital certificate expiry and revocation.

But the PKI model imposes considerable complexity on software applications that use it, resulting in many potential users being intimidated while attempting to understand and use the technology. Also, PKI-based systems are limited in geographical scope for the simple reason that what may be trusted within one cultural community may not be trusted in another. Many stripped down versions of the PKI that provide secure e-mail facilities also exist to provide users secure e-mail with considerable ease compared to using a full-featured PKI system. However, even the simpler systems still rely on digital certificates to identify the user, which retains the need for certification authorities and certificate revocation. Also, the number of steps a user has to perform is considerably high and complicated, given the dearth of e-security education among common e-mail users. These factors prevent PKI technology from widespread use in e-mail systems even though the underlying technology of public key cryptography is fairly strong and reliable.

Moreover, users of Web-based e-mail services (such as Yahoo!, Hotmail, and Google's g-mail) have no way of using the S/MIME or PKI to secure their e-mail. Although the Web service user is provided with an interface to compose, archive, and receive e-mails, there is no control over the actual formation and sending of the messages to provide encryption. The same impediment extends to authentication and verification of e-mails from a Web interface. This poses significant privacy problems to the users of such e-mail services and many personal and business users who want to have secure e-mail communication while traveling.

There also exist secure e-mail systems that act as e-mail gateways and encrypt the mail that passes through the gateway. Typically, these systems require additional gateway software at the receiving end that decrypts the e-mails that come in; so that the recipient sees only a regular unencrypted e-mail at his end. In such cases, the public key of the recipient is transparently obtained by the sending gateway and the private key of the recipient is permanently accessible to the receiving gateway. This system, while easy to use, leaves the e-mails in plain text form in both the sending and receiving systems thus making them vulnerable to unauthorized viewing or tampering. In addition, leaving the private key in possession of the receiving gateway also constitutes an unacceptable compromise of security. Further, these systems do not enable easy portability of senders” and recipients” account information; and security is available only within a user's own e-mail systems. In addition, Web-based mail systems cannot be accessed through these mail systems.

There are yet other secure e-mail systems that provide their own client interfaces, both through standalone applications and Web-based interfaces, that encrypt the mails at the sending end and decrypting them at the receiving end. In many cases, they also use a robust combination of public and symmetric cryptosystems. However, they suffer from one fatal flaw: they are not interoperable with other mail systems, thus defeating the very purpose of Internet-based e-mail.

Therefore there exists a need for a security scheme that is usable across all e-mail systems, that does not require any changes to the infrastructure, that retains all the benefits of an Internet based e-mail system and also enables the users to access their e-mail system from any location. The present invention provides solutions for this need.

### SUMMARY OF THE INVENTION

The present invention provides systems, methods, and apparatus that enable simple, but robust, secure electronic mail transfer.

In a first aspect, the present invention provides a system for sending encrypted electronic messages. In one embodiment, the system of the invention comprises a client computer that is configured to enable a user to compose an electronic text message and define at least one recipient address. The client computer is in (or can be brought into) contact with a mail server that is configured to accept the electronic text message, at least one recipient address, and, optionally, a file attachment, and format such into an e-mail including an e-mail header. The text of the message and, optionally, the file attachment, are encrypted using encryption information that is associated with a Numerical Id specific for the user of client computer and a different Numerical Id for each recipient. The system further comprises a public key distribution server that is configured to receive the recipient's Numerical Id and return to the client computer a public key specific to the recipient.

In some embodiments, the client computer communicates with the mail server using a Web browser interface. In more specific embodiments, the client computer is configured to execute software that is effective to identify the recipient's e-mail address, the electronic text message, and the optional file attachment using the Web browser interface, and encrypt the electronic text message, and the optional file attachment. In some embodiments, the encryption is performed using a public key encryption method; and, in still more particular embodiments, the user's Numerical Id identifies said user's public key and the recipient's Numerical Id identifies the recipient's public key.

In another aspect, the invention provides methods for encrypting electronic communications. In some embodiments, the methods of the invention comprise composing an electronic text message; defining at least one recipient address; contacting a mail server that is configured to accept the electronic text message and the recipient address; and using the electronic text message and the recipient address to send an electronic mail through a mail server. The method also comprises encrypting the electronic text message using a Numerical Id specific for the user of the client computer and a different Numerical Id for the recipient. In more particular embodiments, the method of the invention includes contacting an encryption server that is configured to send a public key for the recipient in response to the encryption key server receiving the recipient's Numerical Id.

In more particular embodiments, the method of the invention includes identifying a file attachment, and, more particularly, encrypting the file attachment.

In yet another aspect, the invention includes a computer-readable medium containing computer program code devices thereon that are configured to enable a computer to encrypt an electronic text message using a Numerical Id specific for the sender of the message and a different Numerical Id for a recipient of the message.

The computer program code devices are further configured to enable the computer to contact a mail server that is configured to accept an electronic text message and a recipient address, format an e-mail including an e-mail header using the electronic text message and recipient address, and forward the encrypted electronic text message and the recipient address to the mail server to cause the mail server to send an encrypted e-mail to the recipient.

These and other aspects and advantages will become apparent when the Description below is read in conjunction with the accompanying Drawings.

### BRIEF DESCRIPTION OF THE DRAWINGS

FIG. 1 illustrates a system of computers and servers in accordance with one embodiment of the invention.

FIG. 2 illustrates a secure e-mail interface in accordance with one embodiment of the invention.

FIG. 3A illustrates a data structure for requesting a recipient's private key according to one embodiment of the present invention.

FIG. 3B illustrates a data structure for the response to the request for a recipient's private key according to one embodiment of the present invention.

### DESCRIPTION OF SOME EMBODIMENTS OF THE INVENTION

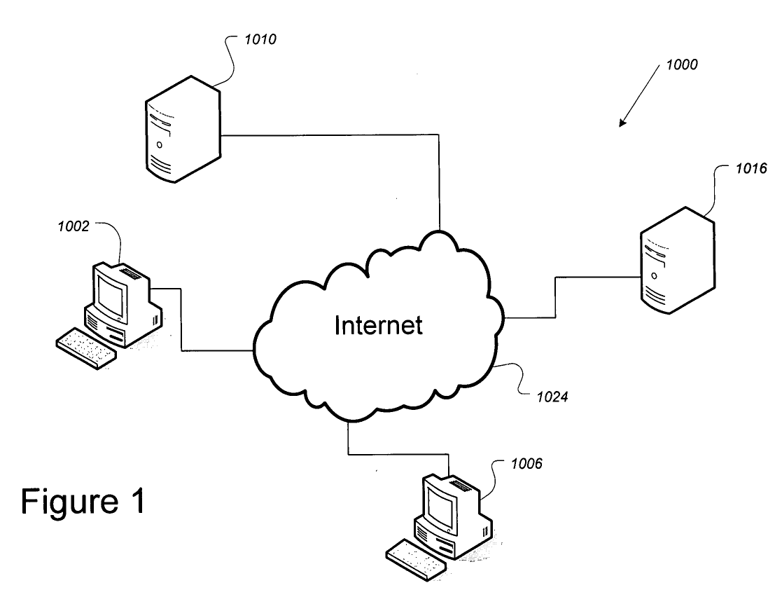

In a first aspect, an example of which is illustrated in FIG. 1, the present invention provides a system (1000) including an e-mail sender (1002) that communicates with an e-mail receiver (1006) through the Internet (1024) or other computer network (not shown). (Although only one e-mail receiver computer is shown in the FIG. 1 it will be understood implicitly that there may be an arbitrary number of e-mail receivers.) Both the e-mail sender and e-mail receiver exchange mail using an e-mail server (1010). Each of these devices also communicates with an encryption key server (1016). The computers and servers just described are of standard design and construction and their operation will be understood by those having ordinary skill in the art.

The e-mail server 1010 is configured to accept textual input including e-mail address(es) and e-mail body content (optionally including formatting information) as well as any attached files from sender 1002, create the necessary header and other information for transmission to receiver 1016, and send the e-mail (including any attachments) to receiver 1006. In some embodiments, server 1010 provides browser e-mail interfaces to sender 1002 and receiver 1006, such as provided by commercial Web service providers such as Yahoo!, Google, and Hotmail, through which the sender provides text input and attachments that are formatted into e-mail and sent to receiver 1006 who retrieves the e-mail content (including any attachments). The details of such operations will be known to those having ordinary skill in the art.

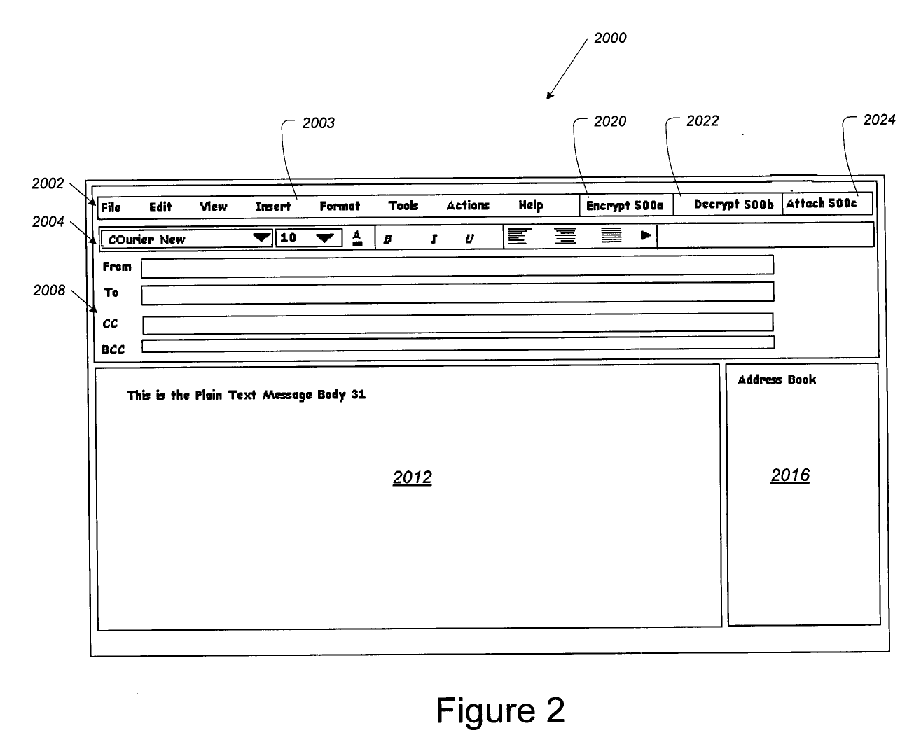

One example of an interface for composing and reviewing e-mail sent according the methods and systems provided by the present invention is shown in FIG. 2. There, an e-mail interface window (2000) includes a row (2002) including menus (2003) for various file and formatting operations on e-mail files available to a user or being composed by a user. The details of the commands and options presented by the different menus shown at 2003 will be familiar to those having ordinary skill in the art. Additional textual formatting options (2004) may be presented as well. Input means for providing address information (2008) such as the return address, address, copies and blind copies is also provided. A window (2012) for inputting the e-mail's body text (i.e., the “payload”) is provided as is an Address Book window (2016) that displays stored addressee information. The details of providing such interfaces and controls will be understood by those having ordinary skill in the art. It will be also appreciated that many variations of the details just described can be provided without departing from the present invention.

In operation, a user, such as sender 1002, composes a message to be sent to receiver 1004 as an e-mail using an interface such as e-mail interface window 2000. This window can be provided by software resident on the user's computer or provided by a remote server, such as e-mail server (1010), e.g., in the form of a Java applet or by operation of an Active-X control. The sender provides the payload text in window 2012, adds any formatting and addressing information using the interface described above, and sends the textual information to a mail server, such as e-mail server (1010), over the Internet or other network. As reviewed above, the e-mail server (1010) takes this information and adds the appropriate headers and routing information to provide a complete e-mail message and sends the message to the receiver (1006). The details of such operations are known to those having ordinary skill in the art.

In a more particular exemplary embodiment in accordance with the present invention, the e-mail interface window (2000) includes additional controls for encrypting (2020) and decrypting (2022) the payload, and attaching (2024) encrypted attachments. The details of these controls per se, such as their placement and form, are not material to the present invention; and the details of their provision as part of a software interface will be understood by those having ordinary skill in the art. The operations effected by those controls and the systems and methods provided by the invention to implement those operations will be discussed hereinbelow.

In one embodiment of the present invention, encrypting, decrypting, and encrypted attachment functions (such as represented by the controls illustrated by 2020, 2022, and 2024 in FIG. 2) are provided to the user as a software module (described below) that can be downloaded directly from a remote server, such as encryption key server 1016 or other server (not shown), to the sender's and receiver's computers (e.g., computer 1002 and 1006) using appropriate network transfer protocols such as Hyper Text Transfer Protocol (HTTP) or File Transfer Protocol (FTP) and installed thereon. The details of providing for such transfer and installation will be familiar to those having ordinary skill in the art.

In a more particular embodiment, the encryption key server (1016) is a secure public key server described in patent application, such as described in co-pending U.S. patent application Ser. No. ______ (Attorney Docket No. KYGLU002) filed on even day herewith and incorporated herein by reference in its entirety and for all purposes. In one exemplary embodiment, the sender obtains a Numerical Id. that represents a public key (and optionally other security information) that is stored at a location that is accessible to the user when the user desires to encrypt an e-mail. For example, the public key can be stored on the user's computer or on a data storage location that is accessible to the user's computer, such as a remote drive or a portable data storage device. According to the instant particular exemplary embodiment, when the Numerical Id is created, public- and private keys are created for the user (e.g., an RSA 1024-bit key). The public key is registered with a secure public key distribution system such as represented by encryption key server 1016. (According to this embodiment, the private key is not registered with the server and does not leave the possession of the owners, i.e., none of the components in the public key server system ever come into contact with user private keys.) Similarly, any receiver of the encrypted message also must have installed the software module described above in their receiving units and have corresponding Numerical Ids. The details of provisioning public- and private keys and corresponding Numerical Ids will be apparent to those having ordinary skill in the art.

In a still more particular embodiment, the software module that provides the encryption of text and attachments as described herein comprises two sub-modules based on their individual functions. In one embodiment, a first sub-module consists of code (for example, Java language code) that is effective to provide manipulation of data present in HTML pages, such as for composing a secure email message from a Web mail interface. A second module consists of programming code that performs the appropriate cryptographic operations for converting a plain text email message to an encrypted form. In a further exemplary embodiment, additional code provided to the invention introduces a toolbar and buttons for initiating the encryption, decryption, and encrypted attachment operations in the Internet browser of the sending unit. The implementation of such code as just described will be apparent to those having ordinary skill in the art.

In one embodiment, the second software module allows for the creation of appropriate files to store the public key and private key of the user as well as a provision for storing details of recipients (such as mappings between their Numerical Ids mapped and their e-mail addresses or identifiers). Additionally, this file stores other user information like alternate e-mail addresses and identifiers that the user may posses and use. This ensures that a user does not have to use different Numerical Ids with different e-mail accounts.

One example of a data structure associated with the overall user profile file is shown below. This data structure consists of the components Header information, Private key (Optional), Profile information of the user, Friend list, and a Flag to determine whether the Private key is actually present in the profile file or in a different file.

| Field Name | Data Type | Description |
|---|---|---|
| Header | struct ProfileFileHeader | Copy of |
| | | ProfileFileHeader |
| | | structure |
| Prikey | struct KeyglooPrivateKey | Pointer to |
| | | KeyglooPrivateKey |
| | | structure |
| Profile | struct PersonalProfile | Copy of |
| | | PersonalProfile |
| | | structure |
| Friends | struct KeyglooFriends | Pointer to |
| | | KeyglooFriends |
| | | structure |
| Flag | int | Denoted if the |
| | | user is primary |
| | | or temporary |

An exemplary structure of a header associated with the profile file of a user is shown below. The first component of the header contains an Id that identifies the file as belonging to the invention by a unique code. The next two components are the major and minor version numbers to ensure that the second software module is in a usable state. The structure then contains a flag that indicates whether the user's private key is present in the profile file. The next field contains the number of entries in the address book contained within the profile file. Additional fields can be added.

| Column Name | Type | Description |
|---|---|---|
| Id | char | Identifier for an encrypted |
| | | file. |
| MajorVersion | char | 1.5 |
| MinorVersion | char | 0.2 |
| PriFlag | int | Set if the private key is |
| | | contained in the profile file. |
| FriendsCount | int | Number of friends in the contact |
| | | list having Keygloo numbers. |

A example of the structure of a PersonalProfile of the profile file of a user is shown below. This structure contains the Numerical Id., the primary e-mail Id of the user, which he uses to register himself with the Web mail server, the number of e-mail Ids that the user has other than the primary e-mail Id and which are associated with the same Numerical Id., the public key of the user, a Signature of the public key and identification number, and a Reaffirmation time to determine if the user has to check the encryption server.

| Column Name | Type | Description |
|---|---|---|
| Numerical Id | char | Id. number of the |
| | | user. |
| Email | char | Primary Email Id of |
| | | the user. |
| Email Count | int | Number of Email Ids |
| | | used by the user for |
| | | the Numerical Id. |
| n | unsigned char | Public key value. |
| Signature | unsigned char | Signature of the |
| | | Public key and |
| | | Numerical Id. |
| | | together. |
| ReaffirmTime | time_t | For identifying if |
| | | it is time for the |
| | | user to reaffirm to |
| | | Encryption Server |
| | | (e.g., 3 months). |

One example of a structure of an address book contained within the profile file is shown below. This structure thus contains the e-mail Ids of recipients of secure e-mails; thus it contains the e-mail addresses (or identifiers), their corresponding Numerical Ids, their public keys, and an index value for each of the users to keep track of the number of entries in the address book. The convenience provided by an address book is that the user does not have to remember the Numerical Ids of his friends every time he encrypts an e-mail message.

| Column Name | Type | Description |
|---|---|---|
| Email | char | Email Id of the friend/ |
| | | recipient |
| Keygloo | char | Keygloo number of that |
| | | friend (Numeric 10- |
| | | digit ID) |
| n | unsigned char | Public key of |
| | | thefriend/recipient |
| Counter | int | Index of a particular |
| | | friend/recipient |

The private key can be stored in the profile file itself. Alternately it can be stored in a separate file. One exemplary private key data structure is shown below and consists of: the Numerical Id; RSA Private key values of P, Q, and D; and a flag indicating whether the private key is protected by a default password or a custom password set by the user.

| Column Name | Type | Description |
|---|---|---|
| Numerical Id. | char | Numerical Id. number |
| | | (e.g., a 10-digit ID) |
| PrivateVals | unsigned char | P, Q, D values |
| d | unsigned char | Private key value |
| DefaultPassword | int | Set if the user is |
| | | using a default |
| | | password for |
| | | decryption |

Thus, with reference to FIGS. 1 and 2, in operation a sender who desires to send encrypted e-mail from a Web-based mail interface first logs-in to his Web mail account (e.g., Yahoo!, Hotmail, or Google) and initializes a mail composition window by clicking the appropriate link. He then fills the “To” field, “CC” field and “BCC” field with the e-mail addresses of the recipients as appropriate. The recipients also use the encryption methods and software of the present invention and thus have possession of their respective Numerical Ids.

The software modules ensure that all information available to carry out the cryptographic operations while composing the secure e-mail are made available in the sender's computer. Once the recipient information is filled, the user goes on to compose the e-mail message which he intends to send in the secure form to the recipient(s). After composing the text, the user clicks the “Encrypt” button present in the toolbar. This action activates the first software sub-module, which essentially consists of Java script functions. Since the e-mail composition page is an HTML page these elements are retrieved using the Java Script functions. These elements contain the data in the “From” field, “To” field, “CC” field, “BCC” field and the actual e-mail message that was typed in by user. On retrieval of the data contained within the elements, the same is passed to the second software sub-module for performing the cryptographic operations on the data passed.

The second software module first scans the data obtained from the “From” field to determine the email address of the sender. The module next retrieves the public key of the sender from the structure PersonalProfile depicted above. The module next obtains the data from the “To”, “CC” and “BCC” fields and retrieves the email addresses of the recipients of the e-mail message; it then obtains their corresponding Numerical Ids from the address book from the structure above.

Once the numerical Ids of the recipients have been obtained, the second software module makes a connection to the encryption key server 1016 and requests the public keys corresponding to the recipients' Numerical Ids.

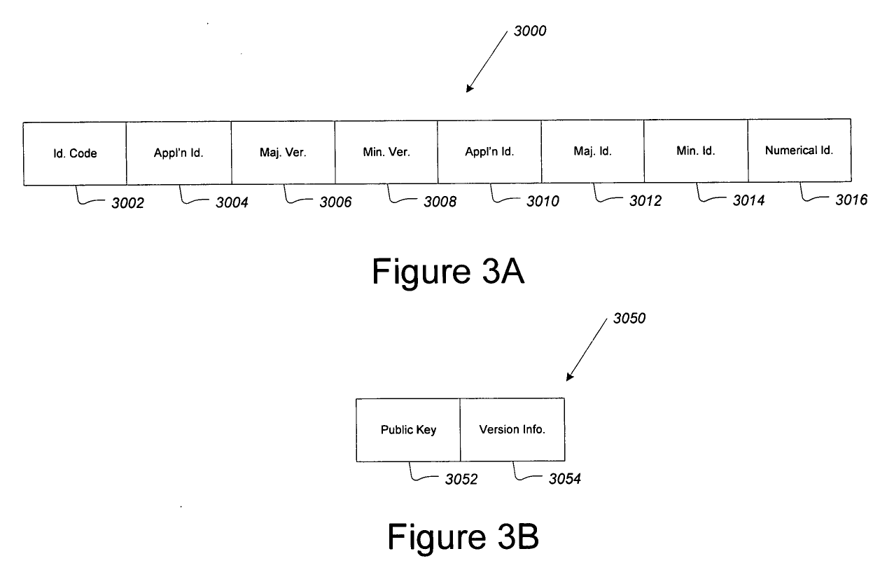

Once the public keys are registered with the encryption server, the server can respond to public key requests from any legitimate software module when that module requires public key corresponding to the Numerical Id. of a recipient for the purpose of encrypting messages and attachments to the recipient. One example of a suitable request (3000) is shown in FIG. 3A. The request format consists of an identification code (3002) that specifies that this is a request for public key. It then contains the application id (3004) of the second software module, the module's major version number (3006) and minor version number (3008). Additionally, string 3000 also contains the Application Id (3010) of any module that is added to the software sub-modules of the invention, the added module's major version number (3012) and minor version number (3014). String 3000 additionally contains the Numerical Id. (3016) for which public key is requested from the encryption server.

The response string (3050) from the encryption server consists of the public key (3052) corresponding to the Numerical Id and version information (3054) is shown in FIG. 3B. On reception of the public key, the software module can make use of the same for the cryptographic operations needed to translate the plain text e-mail to its encrypted form. The software module can similarly obtain the public key for any other recipient.

This done, the module proceeds to generate a session key (e.g., a 256-bit AES session key) which it uses to encrypt the plain text e-mail message. The encrypted session key is further encrypted using the public keys and added to the encrypted message. The encrypted message contains sufficient header information for the recipients to convert the e-mail message from encrypted form to unencrypted form. The encrypted message is additionally subjected to Base-64 encoding so as to ensure that there is no loss of data as the message passes through email servers.

In one embodiment, the message header will include the following information:

An identifier to signify that the content has been encrypted using the system of the invention,

A flag to indicate if the content is encrypted, sender-authenticated or both,

The numerical IDs of all the recipients,

The length of the encrypted content,

The encrypted key (once for each of the recipients),

The Numerical Id of the sender, and

The authentication information computed with the sender's private key.

In some embodiments, the encrypted key is an AES key. In other embodiments, the authentication includes a hash or other indication of integrity such as an SHA-1 digest.

Additional blocks may be appended to the header as well. In some embodiments, one or more of the following blocks is appended:

Field Size Description:

| Field | Size | | Description |
|---|---|---|---|
| Block Identifier | 8 | bytes | An indicator to show |
| | | | that this is a block |
| | | | under the invention. |
| | | | Typical |
| | | | value = 33560000 |
| Major Version | 1 | byte | To accommodate |
| | | | enhancements |
| Minor Version | 1 | byte | To accommodate |
| | | | enhancements |
| File Type | 2 | bytes | Flag to show if the |
| | | | encrypted content is |
| | | | in binary form or in |
| | | | base-64 encoding. Also |
| | | | to show if the content |
| | | | is encrypted or |
| | | | authenticated or both |
| | | | and also to show the |
| | | | encryption algorithm |
| | | | if encrypted. |
| Header Length | 4 | bytes | The length of the |
| | | | header block including |
| | | | the repeated recipient |
| | | | and authenticator |
| | | | information. |
| Content Length | 8 | bytes | The length of the |
| | | | encrypted/ |
| | | | authenticated content |
| Number of Recipients | 2 | bytes | The number of persons |
| | | | who can decrypt the |
| | | | encrypted content |
| Number of | 2 | bytes | The number of persons |
| Authenticators | | | who have authenticated |
| | | | the content. |
| Initialization Vector | 32 | bytes | Initial value for |
| | | | encryption in the |
| | | | symmetric algorithm |

Recipient Information:

| Field | Size | | Description |
|---|---|---|---|
| Numeric ID | 16 | bytes | Numeric ID of the |
| | | | recipient |
| Encrypted Session Key | 240 | bytes | The session key |
| | | | encrypted with the |
| | | | public key of the |
| | | | recipient |

Authenticator Information (Repeated Once for each Number of Authentications):

| Field | Size | | Description |
|---|---|---|---|
| Numeric ID | 16 | bytes | Numeric ID of the |
| | | | authenticator |
| Signature | 240 | bytes | Digest of the |
| | | | authenticated content |
| | | | encrypted with the |
| | | | private key of the |
| | | | authenticator |

In addition to the header explicated above, the invention also adds a more comprehensible header to the encrypted message to indicate to the reader that this is a message encrypted under the invention. This header will have words to the effect “This is an encrypted message under the invention” and may also include a brief description of how to decrypt the said message. A typical encrypted text header will thus look similar to the following:

Keygloo Encrypted Message

Use the Decrypt button in the Keygloo toolbar

(3356330510 91 03 48000 00284 0b100y brg 4Illn nutb6qa DV/Jv w==00000 00000000 00000000 00000000 00000000 00033050 00102000 000GT/pH y0 5CzOqS NC6N1Sa H m/Pf9r x kcME Jq8 OXBSVNIB Yn NxOUjlw iS vRcJUmI UW/ScZ LAjWm zk7 SGO5 VHpq0N0 Iw k5Yy FGhC7NM +W96 i2 4Kqy/ ax LqolE GJP0ucHn CGWX 6dQmNx+ X DIst4 cIin 2JB fT2tRZZ oly/d3GC G2AkqM8=00000000 00000000 00000000 00000000 00000000

The invention also provides methods and systems for encrypting files that are attached to the e-mail message.

One embodiment of this aspect of the invention function similarly to the discussion of payload encryption just described. According to his embodiment, the software module first scans the HTML page to retrieve sender information and recipient information. It then obtains any subsequent pages that aid in attaching a file to the e-mail (e.g., using XMLHTTP). The user operates the command to attach a file, e.g., clicks the ‘Attach’ button (2024 in FIG. 2). The software module now retrieves the file identified by the user (e.g., by selection or typing the directory address) and passes this file information along with the sender and recipient information it retrieved from the appropriate HTML pages to the software module for performing further cryptographic operations on the file. The software module proceeds to encrypt the plaintext file in the same manner as the encryption of the email message as described above. Once the conversion of the plaintext file to the encrypted form is successfully completed, the software module takes appropriate action to replace the original plain text file with the encrypted file in the e-mail. On completion of the preparation of the secure mail, the sending unit may use the facilities provided by the Web mail interface to send the e-mails to the recipients. The foregoing operations can be implemented using methods well known in the art.

Each of the receivers possesses a receiving unit having the appropriate software for decrypting the messages and attachments. In one embodiment, such software is implemented as a module comprising two sub-modules using Java script, and in some embodiments a dynamically linked library (DLL) or other shared object code, to manipulate the elements of the HTML pages that form the interface for the Web mail account of the recipient. The module performs the appropriate cryptographic operations necessary to convert the secure mail to its readable form.

For example, to initiate the conversion of the secured e-mail to the unsecured form, the recipient clicks on the Decrypt button (2022) on the toolbar shown in FIG. 2. A first sub-module scans the HTML page and retrieves the encrypted message from the Web server, which it then passes to a second software module for the decryption operation. The second sub-module, after doing a Base-64 decode operation on the encrypted message, scans the header of the encrypted message to first identify the Numerical Ids for which the e-mail message has been encrypted. It then identifies the Numerical Id of the receiver and prompts the receiver to provide the password, which protects his private key. On obtaining the private key, the second sub-module then decrypts the encrypted session key that is available in the message header as described above. The session key so decrypted is then used to decrypt the actual e-mail message and convert it to the plaintext form. The first sub-module then receives this unencrypted e-mail message from the second sub-module and assigns it to the appropriate element in the HTML page.

The secure mail system provided by the present invention will thus be seen to aid in secure communication over any computer network including the Internet or other network using browser-based or thin client-based e-mail services. The systems of the present invention can be extended to include applications other than e-mail like chat, peer-to-peer file transfers and others as will be understood by those having ordinary skill in the art.

Although various specific embodiments and examples have been described herein, those having ordinary skill in the art will understand that many different implementations of the invention can be achieved without departing from the spirit or scope of this disclosure. For example, encryption and decryption can be performed using a single software module or more than two software modules. The modules described herein can be implemented using a variety of techniques and can be part of the operating system as well as plug-ins. Still other variations will be clear to those having ordinary skill in the art.

What is claimed is:

1. A system for sending encrypted electronic messages, comprising:
a client computer configured to compose an electronic text message and define at least one recipient address; said client computer being in contact with a mail server that is configured to take said electronic text message, at least one recipient address, and, optionally, a file attachment; and format such into an e-mail including an e-mail header;
encryption information for encrypting said electronic text message using a Numerical Id specific for the user of said client computer and a different Numerical Id for said at least one recipient; and
a public key distribution server that is configured to receive said at least one recipient's Numerical Id and return to said client computer a public key specific to the said at least one recipient.

2. The system of claim 1, wherein said client computer communicates with said mail server using a Web browser interface.

3. The system of claim 2, wherein said client computer is configured to execute software that is effective to identify said at least one recipient's e-mail address, said electronic text message, and said optional file attachment using said Web browser interface and encrypt said electronic text message, and said optional file attachment.

4. The system of claim 3, wherein said software is further configured to perform said encryption of said electronic text message, and said optional file attachment using said Numerical Id of said client, the Numerical Id of said at least one recipient, said public key specific to said client computer, and said public key specific to said at least one recipient.

5. The system of claim 4, wherein said software and said client computer are configured to encrypt said electronic text message, and said optional file attachment using a public key encryption method.

6. The system of claim 5, wherein said user's Numerical Id identifies said user's public key.

7. The system of claim 6, wherein said at least one recipient's Numerical Id identifies said at least one recipient's public key.

8. The system of claim 1, further comprising a user information file comprising a private key of a public-private key pair for said user.

9. The system of claim 8, wherein said user information file is located on said client computer.

10. The system of claim 9, wherein said user information file is located externally to said client computer.

11. A method for encrypting electronic communications, comprising:
composing an electronic text message;
defining at least one recipient address;
contacting a mail server that is configured to accept said electronic text message and at least one recipient address, and formatting an e-mail including an e-mail header using said electronic text message and at least one recipient address using said mail server; and
encrypting said electronic text message using a Numerical Id specific for the user of said client computer and a different Numerical Id for said at least one recipient.

12. The method of claim 11, further including identifying a file attachment.

13. The method of claim 12, further including encrypting said file attachment.

14. The method of claim 11, further including contacting an encryption server that is configured to receive said at least one recipient's Numerical Id.

15. The method of claim 14, further including contacting an encryption server that is configured to send a public key for said at least one recipient in response to said encryption server receiving said at least one recipient's Numerical Id.

16. The method of claim 15, further including receiving said at least one recipient's public key.

17. A method of secure electronic communication, comprising sending an electronic message encrypted using the method of claim 11.

18. A method of secure electronic communication, comprising sending a file encrypted using the method of claim 11.

19. A method of secure electronic communication, comprising receiving an electronic message encrypted using the method of claim 11.

20. A method of secure electronic communication, comprising receiving a file encrypted using the method of claim 11.

21. A computer-readable medium containing computer program code devices thereon, said computer program code devices configured to enable a computer to encrypt an electronic text message using a Numerical Id specific for the sender of said message and a different Numerical Id for at least one recipient of said message; contact a mail server that is configured to accept an electronic text message and at least one recipient address and format an e-mail including an e-mail header using said electronic text message and at least one recipient address; and forward said encrypted electronic text message and said recipient address to said mail server to cause said mail server to send an encrypted e-mail to said recipient.

22. A computer-readable medium containing computer program code devices thereon, said computer program code devices configured to enable a computer to decrypt an electronic text message encrypted by a computer using the computer-readable medium of claim 21.
